(19) United States
(12) Patent Application Publication
(10) Pub. No.: US 2008/0151702 A1
(43) Pub. Date: Jun. 26, 2008

(54) CONTENT REPRODUCING SYSTEM, ELECTRONIC APPARATUS, REPRODUCTION CONTROL METHOD, PROGRAM, AND STORAGE MEDIUM

(75) Inventors: Naoki YUASA, Chiba (JP); Masahiro Nakano, Tokyo (JP); Junichi Nakamura, Chiba (JP); Shuichi Otsu, Kanagawa (JP); Hideki Sato, Kanagawa (JP); Hiroki Hashi, Tokyo (JP); Mie Namai, Tokyo (JP); Kosuke Yoshitomi, Kanagawa (JP); Tomoya Narita, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/948,169

(22) Filed: Nov. 30, 2007

(30) Foreign Application Priority Data
Dec. 22, 2006 (JP) 2006-345766

(51) Int. Cl. G11B 20/00

(52) U.S. Cl. 369/24.01

(57) ABSTRACT

In a content reproducing system, the electronic apparatus includes a display controller for controlling display of a content list, a selecting unit for selecting, among the one or more reproducing apparatuses, a reproducing apparatus for reproducing one of the pieces of content, and an instructing unit for instructing the selected reproducing apparatus to reproduction of the selected one of the pieces of content, each of the one or more reproducing apparatuses includes a requesting unit for requesting the content provision apparatus to transmit the selected one of the pieces of content, a receiving unit for receiving the selected one of the pieces of content, and a reproduction controlling unit for controlling reproduction of the selected one of the pieces of content, and the content provision apparatus includes a recording unit for recording the pieces of content, and a transmitting unit for transmitting the selected one of the pieces of content.

### CROSS REFERENCES TO RELATED APPLICATIONS

The present invention contains subject matter related to Japanese Patent Application JP 2006-345766 filed in the Japanese Patent Office on Dec. 22, 2006, the entire contents of which are incorporated herein by reference.

### BACKGROUND OF THE INVENTION

1. Field of the Invention

The present invention relates to content reproducing systems, electronic apparatuses, reproduction control methods, programs, and storage media. Particularly, the present invention relates to a content reproducing system capable of reproducing content with ease, an electronic apparatus, a reproduction control method therefor, a program, and a storage medium.

2. Description of the Related Art

In recent years, a controller capable of not only obtaining content such as a moving image and audio from a server through a network to reproduce the content but also controlling another electronic apparatus connected to the network to reproduce the content has been used.

Some reproducing apparatuses having the following function have been proposed in the related art. In a case where a reproducing apparatus which is used to reproduce content recorded in a server connected to a network displays a list of pieces of content recorded in the server, when the list includes content which is not reproducible using the reproducing apparatus, the reproducing apparatus displays the content with notification representing that the content is not reproducible or the reproducing apparatus does not display any information about the content which is not reproducible in the list (refer to, for example, Japanese Unexamined Patent Application Publication No. 2005-216451).

### SUMMARY OF THE INVENTION

However, in the technique described above, it is difficult for a user to reproduce content with a simple operation using a controller, or using an electronic apparatus or a reproducing apparatus which is controlled using the controller.

For example, in a case where the controller displays a list of pieces of content recorded in a server and a user operates a controller to select one of the pieces of content to be reproduced while checking the list, when the selected one of the pieces of content is not reproducible using the controller, the user has to further operate the controller so that a menu screen is displayed after the user selects the one of the pieces of content to be reproduced, and has to select an electronic apparatus capable of reproducing the selected one of the pieces of content in the menu screen.

Therefore, the user may perform complicated operations to view or listen to desired content or the user may mistakenly select content which is not reproducible resulting in display of an error indication.

Furthermore, in a case where a reproducing apparatus or a controller displays a list of pieces of content and one of the pieces of content is not reproducible using the reproducing apparatus or the controller displaying the list (hereinafter referred to as an “apparatus for display”), if any information indicating that the one of the pieces of content is not reproducible using the apparatus for display is not shown in the list, since the user is not allowed to issue an instruction for reproducing the one of the pieces of content which is not reproducible using the apparatus for display, the user has to gave up reproducing the one of the pieces of content. Furthermore, the user may not even recognize such a piece of content recorded in the server.

Accordingly, it is desirable to provide a content reproducing system capable of reproducing content with ease, an electronic apparatus, a reproduction control method therefor, a program, and a storage medium.

According to an embodiment of the present invention, there is provided a content reproducing system including an electronic apparatus, a content provision apparatus used to provide pieces of content, and one or more reproducing apparatuses used to reproduce the pieces of content, the electronic apparatus, the content provision apparatus, and the one or more reproducing apparatuses being connected to one another via a network. The electronic apparatus includes a display controller configured to control display of a content list which is a list of the pieces of content provided by the content provision apparatus, a selecting unit configured to select, among the one or more reproducing apparatuses, a reproducing apparatus capable of reproducing one of the pieces of content selected from the content list to reproduce the selected one of the pieces of content, and an instructing unit configured to instruct the selected reproducing apparatus to reproduce the selected one of the pieces of content. Each of the one or more reproducing apparatuses includes a requesting unit configured to request the content provision apparatus to transmit the selected one of the pieces of content instructed to be reproduced using the instructing unit, a receiving unit configured to receive the selected one of the pieces of content transmitted from the content provision apparatus through the network in response to the request issued using the requesting unit, and a reproduction controlling unit configured to control reproduction of the selected one of the pieces of content received using the receiving unit. The content provision apparatus includes, a recording unit configured to record the pieces of content, and a transmitting unit configured to transmit the selected one of the pieces of content requested to be transmitted to one of the one or more reproducing apparatuses.

With this configuration, an electronic apparatus controls display of the content list which is a list of pieces of content provided by the content provision apparatus, selects, among the one or more reproducing apparatuses, a reproducing apparatus capable of reproducing one of the pieces of content selected from the content list to reproduce the selected one of the pieces of content, and instructs the selected reproducing apparatus to reproduce the selected one of the pieces of content. The selected reproducing apparatus request the content provision apparatus to transmit the selected one of the pieces of content instructed to be reproduced. The content provision apparatus transmits the selected one of the pieces of content requested to be transmitted to the selected reproducing apparatus in response to the request issued from the selected reproducing apparatus. Furthermore, the selected reproducing apparatus receives the selected one of the pieces of content transmitted from the content provision apparatus through the network and controls reproduction of the received one of the pieces of content.

According to another embodiment of the present invention, there is provided an electronic apparatus including a display controlling unit configured to control display of a content list which is a list of pieces of content, a selecting unit configured to select, among one or more apparatuses connected to one another through a network, an apparatus capable of reproducing one of the pieces of content selected from the content list to reproduce the selected one of the pieces of content, and an instructing unit configured to instruct the selected apparatus to reproduce the selected one of the pieces of content.

The electronic apparatus may further include a reproduction controlling unit configured to control reproduction of the selected one of the pieces of content. The selecting unit may determine whether the selected one of the pieces of content is reproducible using the electronic apparatus. The reproduction controlling unit may control the reproduction of the selected one of the pieces of content when it is determined that the selected one of the pieces of content is reproducible using the electronic apparatus. The instructing unit may instruct the selected apparatus to reproduce the selected one of the pieces of content when it is determined that the selected one of the pieces of content is not reproducible using the electronic apparatus.

The display controlling unit may control display of the content list so that, in the content list, pieces of information representing pieces of content which are not reproducible using the electronic apparatus are displayed in a display format different from a display format for pieces of information representing pieces of content which are reproducible using the electronic apparatus.

The electronic apparatus may further includes a receiving unit for receiving pieces of profile information which represent a function of reproducing one of the pieces of content, which are included in the corresponding one or more apparatuses, and which are transmitted through the network from the one or more apparatuses. On the basis of the pieces of profile information, the selecting unit may select, among the one or more apparatuses, at least one apparatus capable of reproducing the selected one of the pieces of content, and further select, among the at least one apparatus capable of reproducing the selected one of the pieces of content, an apparatus to reproduce the selected one of the pieces of content.

The display controlling unit may control a list of the one or more apparatuses capable of reproducing the selected one of the pieces of content. The selecting unit may select, from the list of the one or more apparatuses, an apparatus which reproduces the selected one of the pieces of content.

The selecting unit may select, among the one or more apparatuses capable of reproducing the selected one of the pieces of content, an apparatus which reproduced one of the pieces of content the last time, an apparatus which is detected first on the network, or an apparatus specified by a user in advance, as an apparatus which reproduces the selected one of the pieces of content.

According to a further embodiment of the present invention, there is provided a reproduction control method including the steps of controlling display of a content list which is a list of pieces of content, selecting, among one or more apparatuses connected to one another through a network, an apparatus capable of reproducing one of the pieces of content selected from the content list to reproduce the selected one of the pieces of content, and controlling an instruction for reproducing the selected one of the pieces of content which is to be issued to the selected apparatus.

With this configuration, display of a content list which is a list of pieces of content is controlled, among one or more apparatuses connected to one another through a network, an apparatus capable of reproducing one of the pieces of content selected from the content list to reproduce the selected one of the pieces of content is selected, and reproduction of the selected one of the pieces of content which is to be issued to the selected apparatus is controlled.

Accordingly, reproduction of one of the pieces of content is controlled. Particularly, usability is improved.

### BRIEF DESCRIPTION OF THE DRAWINGS

FIG. 1 is a diagram illustrating a configuration of a content reproducing system to which the present invention is applied according to an embodiment of the present invention;

FIG. 2 is a diagram illustrating examples of configurations of a controller, a server, and a renderer;

FIG. 3 is a diagram illustrating an example of display of a content list;

FIG. 4A shows a flowchart illustrating reproducing processing performed using the controller, distribution processing performed using the server, and a reproducing processing performed using the renderer;

FIG. 4B shows a flowchart illustrating reproducing processing performed using the controller, distribution processing performed using the server, and a reproducing processing performed using the renderer;

FIG. 5 is a flowchart illustrating content-list display processing;

FIG. 6 is a flowchart illustrating renderer selection processing; and

FIG. 7 is a block diagram illustrating an example of a configuration of a personal computer.

### DESCRIPTION OF THE PREFERRED EMBODIMENTS

Before describing an embodiment of the present invention, the correspondence between the features of the claims and the specific elements disclosed in an embodiment of the present invention is discussed below. This description is intended to assure that an embodiment(s) supporting the claimed invention are described in this specification. Thus, even if an element in the following embodiment(s) is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

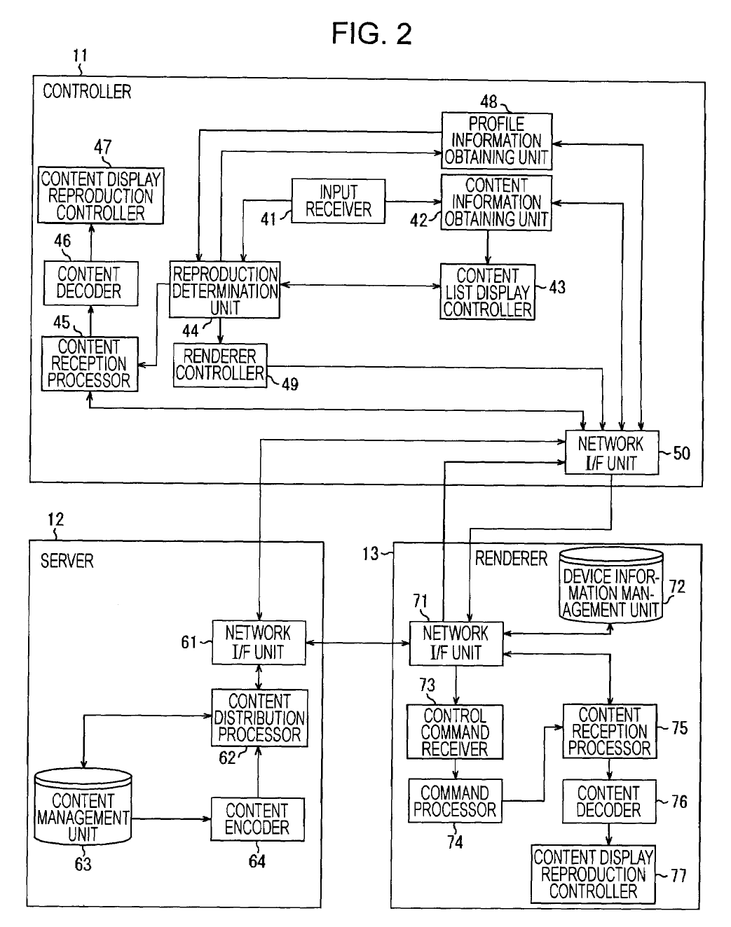

A content reproducing system includes an electronic apparatus (for example, a controller 11 shown in FIG. 2), a content provision apparatus (for example, a server 12 shown in FIG. 2) used to provide pieces of content, and one or more reproducing apparatuses (for example, a renderer 13 shown in FIG. 2) used to reproduce the pieces of content. The electronic apparatus, the content provision apparatus, and the one or more reproducing apparatuses are connected to one another via a network. The electronic apparatus includes, a display controller (for example, a content list display controller 43 shown in FIG. 2) configured to control display of a content list which is a list of the pieces of content provided by the content provision apparatus, a selecting unit (for example, a reproduction determination unit 44 shown in FIG. 2) configured to select, among the one or more reproducing apparatuses, a reproducing apparatus capable of reproducing one of the pieces of content selected from the content list to reproduce the selected one of the pieces of content, and an instructing unit (for example, a renderer controller 49 shown in FIG. 2) configured to instruct the selected reproducing apparatus to reproduce the selected one of the pieces of content. Each of the one or more reproducing apparatuses includes a requesting unit (for example, a content reception processor 75 shown in FIG. 2) configured to request the content provision apparatus to transmit the selected one of the pieces of content instructed to be reproduced using the instructing unit, a receiving unit (for example, a network I/F unit 71 shown in FIG. 2) configured to receive the selected one of the pieces of content transmitted from the content provision apparatus through the network in response to the request issued using the requesting unit, and a reproduction controlling unit (for example, a content display reproduction controller 77 shown in FIG. 2) configured to control reproduction of the selected one of the pieces of content received using the receiving unit. The content provision apparatus includes, a recording unit (for example, a content management unit 63 shown in FIG. 2) configured to record the pieces of content, and a transmitting unit (for example, a network I/F unit 61 shown in FIG. 2) configured to transmit the selected one of the pieces of content requested to be transmitted to the selected reproducing apparatuses.

An electronic apparatus (for example, a controller 11 shown in FIG. 2) includes a display controlling unit (for example, a content list display controller 43 shown in FIG. 2) configured to control display of a content list which is a list of pieces of content, a selecting unit (for example, a reproduction determination unit 44 shown in FIG. 2) configured to select, among one or more apparatuses (for example, a renderer 13 shown in FIG. 2) connected to one another through a network, an apparatus capable of reproducing one of the pieces of content selected from the content list to reproduce the selected one of the pieces of content, and an instructing unit (for example, a renderer controller 49 shown in FIG. 2) configured to instruct the selected apparatus to reproduce the selected one of the pieces of content.

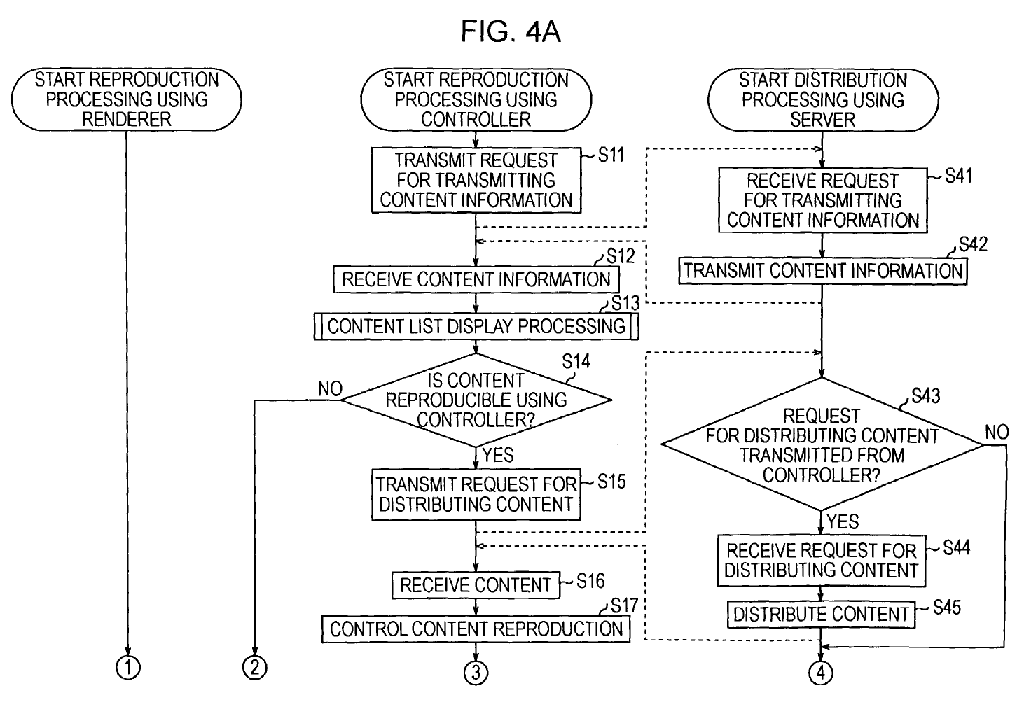

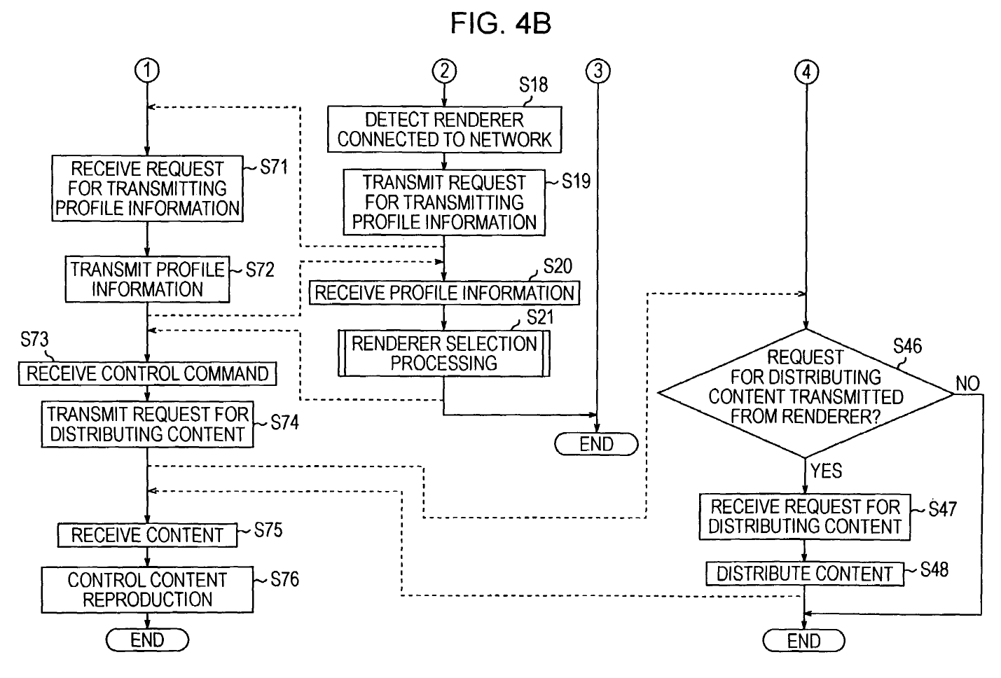

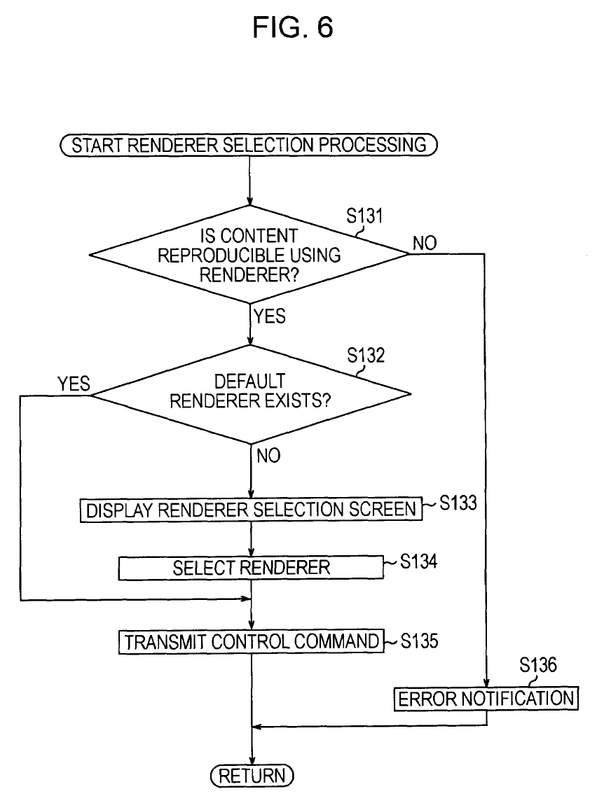

The electronic apparatus may further includes a reproduction controlling unit (for example, a content display reproduction controller 47 shown in FIG. 2) configured to control reproduction of the selected one of the pieces of content. The selecting unit determines whether the selected one of the pieces of content is reproducible using the electronic apparatus (for example, step S14 of FIG. 4), the reproduction controlling unit controls the reproduction of the selected one of the pieces of content when it is determined that the selected one of the pieces of content is reproducible using the electronic apparatus (for example, step S17 of FIG. 4), and the instructing unit instructs the selected apparatus to reproduce the selected one of the pieces of content when it is determined that the selected one of the pieces of content is not reproducible using the electronic apparatus (for example, step S135 of FIG. 6).

The electronic apparatus may further include a receiving unit (for example, a network I/F unit 50 shown in FIG. 2) configured to receive pieces of profile information which represent a function of reproducing one of the pieces of content, which are included in the corresponding one or more apparatuses, and which are transmitted through the network from the one or more apparatuses. On the basis of the pieces of profile information, the selecting unit selects, among the one or more apparatuses, at least one apparatus capable of reproducing the selected one of the pieces of content, and further selects, among the at least one apparatus capable of reproducing the selected one of the pieces of content, an apparatus to reproduce the selected one of the pieces of content (for example, step S131 to step S134 of FIG. 6).

The display controlling unit may control a list of the one or more apparatuses capable of reproducing the selected one of the pieces of content (for example, step S133 of FIG. 6). The selecting unit may select, from the list of the one or more apparatuses, an apparatus which reproduces the selected one of the pieces of content (for example, step S134 of FIG. 6).

The selecting unit may select, among the one or more apparatuses capable of reproducing the selected one of the pieces of content, an apparatus which reproduced one of the pieces of content the last time, an apparatus which is detected first on the network, or an apparatus specified by a user in advance, as an apparatus which reproduces the selected one of the pieces of content (for example, step S131 of FIG. 6).

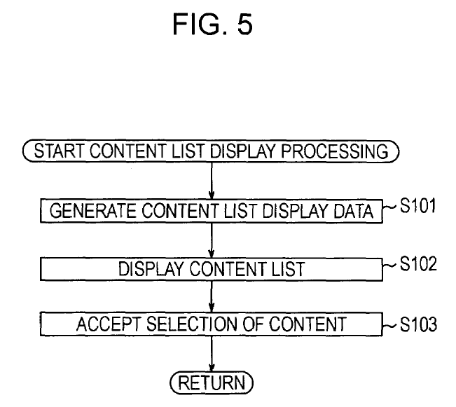

A reproduction control method includes and a storage medium including a program which makes a computer execute the steps of controlling display of a content list which is a list of pieces of content (for example, step S102 of FIG. 5), selecting, among one or more apparatuses connected to one another through a network, an apparatus capable of reproducing one of the pieces of content selected from the content list to reproduce the selected one of the pieces of content (for example, step S131 to step S134 of FIG. 6), and controlling an instruction for reproducing the selected one of the pieces of content which is to be issued to the selected apparatus (for example, step S135 of FIG. 6).

Embodiments of the present invention will be described hereinafter with reference to the accompanying drawings.

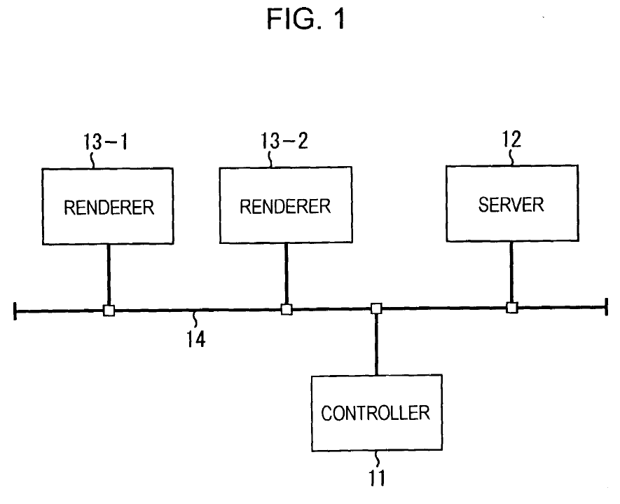

FIG. 1 is a diagram illustrating a configuration of a content reproducing system according to an embodiment to which the present invention is applied.

In FIG. 1, the content reproducing system includes a controller 11, a server 12, a renderer 13-1, a renderer 13-2, and a network 14. The controller 11, the server 12, the renderer 13-1, and the renderer 13-2 are connected to one another through the network 14.

The controller 11 is a portable terminal device such as a special terminal device, a PDA (Personal Digital Assistants), and a game device. The controller 11 receives pieces of information about pieces of content from the server 12 through the network 14 and displays a content list which is a list of the pieces of content recorded in the server 12. Furthermore, the controller 11 obtains one of the pieces of content recorded in the server 12 and reproduces the obtained one of the pieces of content.

The pieces of content recorded in the server 12 are, for example, still images such as pictures, moving images, and audio such as pieces of music.

The controller 11 transmits a control command through the network 14 to the renderer 13-1 or the renderer 13-2 to thereby control the renderer 13-1 or the renderer 13-2 to reproduce one of the pieces of content recorded in the server 12.

The server 12 transmits the pieces of content or the pieces of information about the pieces of content to the controller 11, the renderer 13-1, or the renderer 13-2 in response to a request issued from the controller 11, the renderer 13-1, or the renderer 13-2.

Each of the renderer 13-1 and the renderer 13-2 is constituted by a television receiver or a personal computer, for example. When receiving a control command transmitted from the controller 11, one of the renderer 13-1 and the renderer 13-2, for example, issues a request for transmission of one of the pieces of content to the server 12 in accordance with the control command. Furthermore, one of the renderer 13-1 and the renderer 13-2 receives and reproduces one of the pieces of content transmitted from the server 12 through the network 14. Note that when the renderer 13-1 and the renderer 13-2 are not necessarily distinguished, they are simply referred to as a renderer 13.

The network 14 which connects the controller 11, the server 12, and the renderer 13 to one another is constituted by a wireless LAN (Local Area Network) based on the IEEE (Institute of Electrical and Electronic Engineers) 802.11 standard, or a wired LAN based on the Ethernet (registered trademark) standard.

FIG. 2 is a block diagram illustrating examples of configurations of the controller 11, the server 12, and the renderer 13.

In FIG. 2, the controller 11 includes an input receiver 41, a content information obtaining unit 42, a content list display controller 43, a reproduction determination unit 44, a content reception processor 45, a content decoder 46, a content display reproduction controller 47, a profile information obtaining unit 48, a renderer controller 49, and a network I/F (interface) unit 50.

The server 12 includes a network I/F unit 61, a content distribution processor 62, a content management unit 63, and a content encoder 64.

The renderer 13 includes a network I/F unit 71, a device information management unit 72, a control command receiver 73, a command processor 74, a content reception processor 75, a content decoder 76, and a content display reproduction controller 77.

The input receiver 41 included in the controller 11 receives an input supplied by means of an operation of an input unit including buttons and switches (not shown) which is arranged in the controller 11 and which is operated by a user. That is, the input receiver 41 instructs the content information obtaining unit 42 and the reproduction determination unit 44 to perform various processes in accordance with an operation signal supplied from the input unit operated by the user.

The content information obtaining unit 42 obtains pieces of content information from the server 12 through the network I/F unit 50. The pieces of content information represent the pieces of content which are recorded in the server 12, that is, which are to be transmitted to the controller 11 or the renderer 13. The content information obtaining unit 42 supplies the obtained pieces of content information to the content list display controller 43.

Each of the pieces of content information is used to identify a corresponding one of the pieces of content to be transmitted from the server 12. Each of the pieces of content information includes content list information which is used to display a list of pieces of content to be transmitted, and content attribute information which is information about content reproduction.

For example, the content list information includes a content name, information representing an address of a portion in the server 12 where the corresponding one of the pieces of content is recorded, the information representing an address being described in a URI (Uniform Resource Identifier) method, information representing one of categories such as a picture or music, and other information such as a thumbnail image of the corresponding one of the pieces of content. The content list information is included in each of the pieces of content recorded in the server 12.

Note that, the information which indicates an address of a position in the server 12 where the corresponding one of the pieces of content is recorded and which is described in the URI method is simply referred to as a “content URI” as needed.

The content attribute information includes, for example, a content name, codec-type information which indicates a codec type such as a codec of an content encoding method or a codec of a content decoding method, a period of content reproduction, an angle of view of the corresponding one of the pieces of content, a size of an image to be displayed, a content file size, information about a category of the corresponding one of the pieces of content, and protocol-type information indicating a protocol used at a time of content transmission. The content attribute information is assigned to each of the pieces of content recorded in the server 12.

The content list display controller 43 generates display data used to display the content list which is a list of the pieces of content to be distributed from the server 12 in accordance with one of the pieces of content information supplied from the content information obtaining unit 42. Furthermore, the content list display controller 43 supplies the generated display data to a display unit (not shown) such as an LCD (Liquid Crystal Display) so that the content list is displayed on the display unit.

Moreover, the content list display controller 43 supplies one of the pieces of content information transmitted from the content information obtaining unit 42 to the reproduction determination unit 44.

The reproduction determination unit 44 determines whether one of the pieces of content selected by the user is reproducible using the controller 11 on the basis of one of the pieces of content information supplied from the content list display controller 43. In accordance with a result of the determination, the reproduction determination unit 44 instructs the content reception processor 45 to reproduce the selected one of the pieces of content or instructs the profile information obtaining unit 48 to obtain profile information of the renderer 13.

Here, the profile information is recorded in the renderer 13 in advance and used to identify content reproducible using the renderer 13. Specifically, the profile information represents a function of the renderer 13 of reproducing the content. The profile information includes, for example, a limit size of the image as one of the pieces of content which is reproducible using the renderer 13, a protocol which is usable at a time of reception of one of the pieces of content, and a codec compatible with the renderer 13.

The reproduction determination unit 44 determines whether one of the pieces of content selected by the user is reproducible using the renderer 13 on the basis of the corresponding one of the pieces of content information supplied from the content list display controller 43 and the profile information supplied from the profile information obtaining unit 48. In accordance with a result of the determination, the reproduction determination unit 44 instructs the renderer controller 49 to reproduce the corresponding one of the pieces of content.

The content reception processor 45 obtains one of the pieces of content, that is, one of pieces of content data used to reproduce the one of the pieces of content, from the server 12 through the network I/F unit 50 in accordance with the instruction issued from the reproduction determination unit 44. Then, the content reception processor 45 supplies the obtained one of the pieces of content data to the content decoder 46.

The content decoder 46 decodes one of the pieces of content data supplied from the content reception processor 45 by a predetermined method and supplies the decoded one of the pieces of content data representing one of the pieces of content to the content display reproduction controller 47. The content display reproduction controller 47 controls reproduction of the one of the pieces of content supplied from the content decoder 46. That is, the content display reproduction controller 47 may supply the one of the pieces of content data supplied from the content decoder 46 to the display unit included in the controller 11 so that an image is displayed on the display unit. In addition, the content display reproduction controller 47 may supply audio data to a speaker (not shown) included in the controller 11 so that audio is output.

The profile information obtaining unit 48 obtains profile information of the renderer 13 through the network I/F unit 50 in accordance with the instruction issued from the reproduction determination unit 44 and supplies the obtained profile information to the reproduction determination unit 44.

In accordance with the instruction issued from the reproduction determination unit 44, the renderer controller 49 transmits a control command through the network I/F unit 50 to the renderer 13 to thereby control the renderer 13 to reproduce one of the pieces of content. The network I/F unit 50 included in the controller 11 is used to communicate with the server 12 or the renderer 13 through the network 14 so as to transmit/receive the pieces of content and a variety of information.

The network I/F unit 61 included in the server 12 is used to communicate with the controller 11 or the renderer 13 through the network 14 so as to transmit/receive the pieces of content and a variety of information. The content distribution processor 62 transmits one of the pieces of content information and a corresponding one of the pieces of content supplied from the content management unit 63 or the content encoder 64 to the controller 11 or the renderer 13 through the network I/F unit 61 in accordance with a request from the controller 11 or the renderer 13.

The content management unit 63 stores pieces of content data and pieces of content information and supplies one of the pieces of content data and a corresponding one of the pieces of content information to the content distribution processor 62 or the content encoder 64. The content encoder 64 encodes the supplied one of the pieces of content by a predetermined method and supplies the encoded one of the pieces of content to the content distribution processor 62.

The network I/F unit 71 included in the renderer 13 is used to communicate with the controller 11 or the server 12 through the network 14 so as to transmit/receive a pieces of content and a variety of information such as profile information. The device information management unit 72 stores profile information thereof and transmits the profile information to the controller 11 through the network I/F unit 71 in accordance with a request from the controller 11.

The control command receiver 73 receives a control command transmitted from the controller 11 through the network I/F unit 71 and supplies the control command to the command processor 74. The command processor 74 executes the control command supplied from the control command receiver 73 to instruct the content reception processor 75 to reproduce one of the pieces of content.

In accordance with the instruction issued from the command processor 74, the content reception processor 75 obtains one of the pieces of content, that is, one of the pieces of content data used to reproduce the one of the pieces of content, from the server 12 through the network I/F unit 71 and supplies the one of the pieces of content data to the content decoder 76.

The content decoder 76 decodes one of the pieces of content data supplied from the content reception processor 75 by a predetermined method and supplies the decoded one of the pieces of content data representing one of the pieces of content to the content display reproduction controller 77. The content display reproduction controller 77 controls reproduction of the one of the pieces of content supplied from the content decoder 76. That is, the content display reproduction controller 77 may supply the one of the pieces of content data supplied from the content decoder 76 to a display unit (not shown) included in the renderer 13 so that an image is displayed on the display unit. Furthermore, the content display reproduction controller 47 may supply audio data to a speaker (not shown) included in the renderer 13 so that audio is output. It is assumed that a plurality of renderers 13 are provided hereinafter.

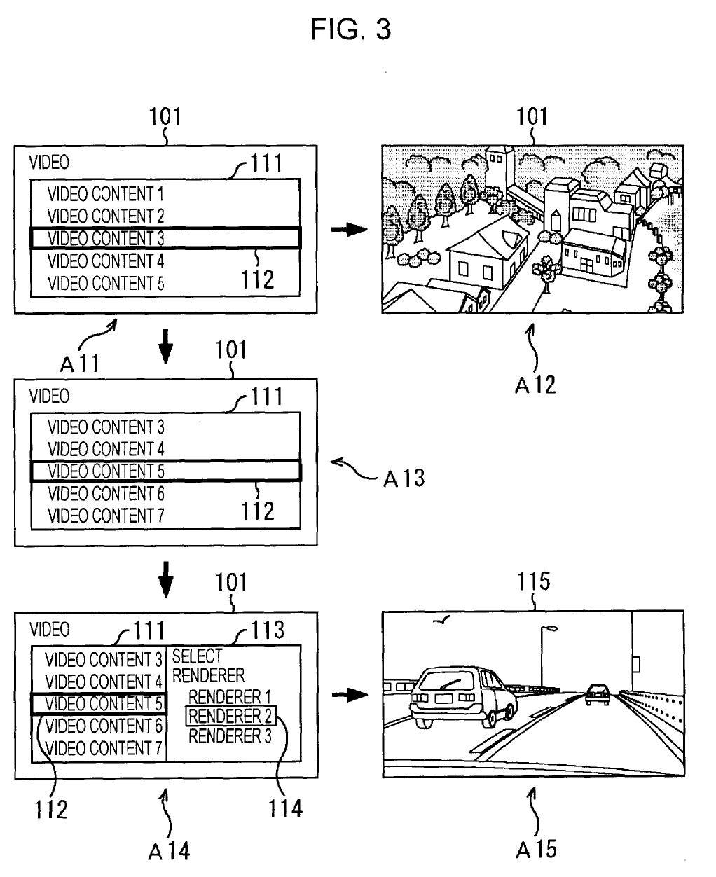

When the user instructs display of the content list, the controller 11 displays the content list in which pieces of content which are allowed to be distributed from the server 12 are arranged in categories as shown in FIG. 3.

Referring to FIG. 3, as indicated by an arrow A11, a content list 111 is shown in a display screen 101 of the display unit included in the controller 11. Pieces of information representing pieces of content categorized in a category “video” are arranged and displayed in the content list 111.

That is, the content list 111 indicated by the arrow A11 includes information representing one of the pieces of content having a content name of “video content 1”, information representing one of the pieces of content having a content name of “video content 2”, information representing one of the pieces of content having a content name of “video content 3”, information representing one of the pieces of content having a content name of “video content 4”, and information representing one of the pieces of content having a content name of “video content 5” which are arranged in this order.

Here, a character string “video content 5” indicating the information representing one of the pieces of content having the content name of “video content 5” is displayed in a display format different from other character strings indicating the other pieces of information representing the pieces of content having the content names of “video content 1” to “video content 4”. This shows that the one of the pieces of content having the content name of “video content 5” is not reproducible using the controller 11.

In an example shown in FIG. 3, the character string “video content 5” is grayed out. However, the character string “video content 5” may be displayed as a character string having color or brightness different from other character strings indicating the other pieces of content, or may be displayed as a reversed character string. As described above, since the information indicating one of the pieces of content which is not reproducible using the controller 11 is displayed in a display format different from the others, the user easily recognizes pieces of content reproducible using the controller 11.

Note that the information indicating one of the pieces of content which is not reproducible using the controller 11 may be displayed in a display format the same as that used for displaying the pieces of information indicating the other pieces of content which are reproducible using the controller 11.

Furthermore, a cursor 112 is displayed in the content list 111. The user moves the cursor 112 by operating the input unit arranged on the controller 11 and instructs reproduction of a desired one of the pieces of content which is selected using the cursor 112, that is, which is focused upon using the cursor 112.

In the content list 111 indicated by the arrow A11, a character string “video content 3” indicating the information representing one of the pieces of content which is reproducible using the controller 11 is selected using the cursor 112. When the user instructs reproduction of the selected one of the pieces of content corresponding to the information indicated by the character string “video content 3”, the one of the content selected by the user is reproduced and displayed as an image indicated by an arrow A12 in the display screen 101 of the controller 11.

For example, as indicated by an arrow A13, in a state where the user selects one of the pieces of information representing one of the pieces of content which is not reproducible, when the user instructs reproduction of the selected one of the pieces of content, a renderer selection screen 113 used to select one of a plurality of renderers 13 for reproducing the one of the pieces of content corresponding to the one of the pieces of information selected using the cursor 112, that is, for reproducing the one of the pieces of content to be reproduced in accordance with the instruction issued by the user, is displayed as indicated by an arrow A14.

In the renderer selection screen 113, a list of pieces of information representing some of the plurality of renderers 13 which allow the one of the pieces of content selected by the user to be reproduced is displayed along with a message “Select renderer” which prompts the user to select one of the plurality of renderers 13. Specifically, information representing one of the renderers 13 having a name of “renderer 1”, information representing one of the renderers 13 having a name of “renderer 2”, and information representing one of the renderers 13 having a name of “renderer 3” are arranged and displayed in the renderer selection screen 113.

The user operates the input unit in order to move a cursor 114 displayed in the renderer selection screen 113 so as to select one of the pieces of information representing the renderers 13. When the user thus selects one of the pieces of information, that is, one of the renderers 13 used to reproduce the one of the pieces of content, the controller 11 instructs the one of the renderers 13 selected by the user to reproduce the one of the pieces of content.

When the controller 11 instructs the one of the renderers 13 selected by the user to reproduce the one of the pieces of content, the one of the renderers 13 obtains the one of the pieces of content from the server 12 so as to reproduce the one of the pieces of content. By this, an image of the one of the pieces of content is displayed in a display screen 115 of the display unit included in the selected one of the renderers 13.

As described above, in a case where one of the pieces of content selected by the user is reproducible using the controller 11, the controller 11 obtains the one of the pieces of content from the server to reproduce it. On the other hand, in a case where one of the pieces of content selected by the user is not reproducible using the controller 11, one of the renderers 13 having a function of reproducing the one of the pieces of content is selected by the user, and the selected one of the renderers 13 reproduces the selected one of the pieces of content. Accordingly, even when one of the pieces of content in which the user wishes to view or listen to is not reproducible using the controller 11, the user selects one of the renderers 13 using the renderer selection screen 113 displayed when the user selected the one of the pieces of content which is not reproducible using the controller 11. With this simple operation, the selected one of the pieces of content is reproduced and the user views and listens to the reproduced one of the pieces of content.

Referring to flowcharts shown in FIGS. 4A and 4B, reproduction processing performed using the controller 11, reproduction processing performed using one of the renderers 13, and content distribution processing performed using the server 12 will be described. In the reproduction processing performed using the controller 11, the controller 11 displays the content list 111 in accordance with a user's operation. In the reproduction processing performed using one of the renderers 13, one of the renderers 13 reproduces one of the pieces of content in response to an instruction issued from the controller 11. In the content distribution processing performed using the server 12, the server 12 distributes one of the pieces of content in response to a request from the controller 11 or the renderer 13.

The user operates the controller 11 to instruct display of the content list, the network I/F unit 50 transmits to the server 12 a request for transmitting pieces of content information in step S11.

That is, when receiving an operation signal generated in accordance with the user's operation from the input unit, the input receiver 41 instructs the content information obtaining unit 42 to obtain the pieces of content information. In accordance with the instruction, the content information obtaining unit 42 transmits a transmission request for transmitting the pieces of content information through the network I/F unit 50 to the server 12.

When the transmission request is transmitted from the controller 11 to the server 12, the network I/F unit 61 included in the server 12 receives the transmission request transmitted from the controller 11 in step S41, and supplies the transmission request to the content distribution processor 62. In accordance with the transmission request supplied from the network I/F unit 61, the content distribution processor 62 obtains the pieces of content information from the content management unit 63 and supplies the pieces of content information to the network I/F unit 61.

In step S42, the network I/F unit 61 transmits the pieces of content information supplied from the content distribution processor 62 to the controller 11. Note that if an amount of data corresponding to the pieces of content information is large, the pieces of content information is not necessarily transmitted at once but may be transmitted several times by dividing the pieces of content information. In such a case, for example, pieces of content list information included in the pieces of content information are transmitted to the controller 11 first, and then pieces of content attribute information included in the pieces of content information are transmitted to the controller 11.

When the pieces of content information are transmitted from the server 12 to the controller 11, the network I/F unit 50 included in the controller 11 receives the pieces of content information transmitted from the server 12 in step S12 and supplies the pieces of content information to the content information obtaining unit 42. The content information obtaining unit 42 supplies the pieces of content information supplied from the network I/F unit 50 to the content list display controller 43. The pieces of content information are further supplied from the content list display controller 43 to the reproduction determination unit 44.

In step S13, the controller 11 performs content list display processing. The content list display processing will be described in detail hereinafter. Note that the controller 11 displays, for example, the content list 111 shown in FIG. 3 on the basis of the pieces of content information obtained from the server 12 in the content list display processing.

When the content list is displayed using the controller 11, the user operates the input unit of the controller 11 in order to move a cursor displayed on the content list and instructs reproduction of one of the pieces of content. The input receiver 41 accepts an input in accordance with the user's operation which is performed using the input unit and which instructs the reproduction of one of the pieces of content, and instructs the reproduction determination unit 44 to reproduce the one of the pieces of content selected by the user.

In step S14, the reproduction determination unit 44 determines whether the one of the pieces of content selected by the user is reproducible using the controller 11 on the basis of a corresponding one of the pieces of content information supplied from the content list display controller 43.

That is, the reproduction determination unit 44 stores therein profile information representing a function of the controller 11 of reproducing one of the pieces of content. The controller 11 determines whether the one of the pieces of content selected by the user is reproducible with reference to the profile information and content attribute information included in the one of the pieces of content information.

For example, in a case where the controller 11 is not compatible with a codec of the one of the pieces of content selected to be reproduced by the user, the codec being included in the content attribute information, that is, in a case where information indicating the codec included in the content attribute information is not included in the profile information, the reproduction determination unit 44 determines that the one of the pieces of content selected by the user is not reproducible using the controller 11. Furthermore, in a case where the controller 11 is not compatible with a category of the one of the pieces of content identified by the content attribute information, a size of an image to be displayed, or a protocol used at a time of transmission, the reproduction determination unit 44 determines that the one of the pieces of content selected by the user is not reproducible using the controller 11.

In step S14, when it is determined that the one of the pieces of content selected by the user is reproducible using the controller 11, the reproduction determination unit 44 supplies information used to identify the one of the pieces of content to the content reception processor 45. The information used to identify the one of the pieces of content includes, for example, a content URI, a content name, and a reproduction starting position of the one of the pieces of content. In addition, the reproduction determination unit 44 instructs the content reception processor 45 to reproduce the one of the pieces of content selected by the user, and the process proceeds to step S15.

In step S15, the content reception processor 45 generates a content distribution request which is a request for distributing the one of the pieces of content selected to be reproduced by the user on the basis of the information used to identify the one of the pieces of content supplied from the reproduction determination unit 44, and transmits the content distribution request to the server 12 through the network I/F unit 50. Specifically, the content reception processor 45 supplies the content distribution request to the network I/F unit 50, and the network I/F unit 50 transmits the content distribution request to the server 12.

When the content distribution request is transmitted from the controller 11 to the server 12, the network I/F unit 61 of the server 12 determines whether the content distribution request is transmitted from the controller 11 in step S43. For example, in a case where it is determined that the one of the pieces of content selected by the user is not reproducible using the controller 11 in step S14, and therefore, the content distribution request is not transmitted from the controller 11 to the server 12 in step S15, the network I/F unit 61 determines that the content distribution request is not transmitted from the controller 11 in step S43.

When it is determined that the content distribution request is not transmitted from the controller 11 in step S43, operations to be performed in steps S44 and S45 are skipped and the process proceeds to step S46.

On the other hand, it is determined that the content distribution request is transmitted from the controller 11 in step S43, the process proceeds to step S44 where the network I/F unit 61 receives the content distribution request transmitted from the controller 11 and supplies the content distribution request to the content distribution processor 62.

In step S45, the content distribution processor 62 distributes the one of the pieces of content which is requested to be distributed in response to the content distribution request supplied from the network I/F unit 61, and the process proceeds to step S46. That is, the content distribution processor 62 obtains the one of the pieces of content requested to be distributed from the content management unit 63 and supplies the one of the pieces of content to the network I/F unit 61.

In a case where the one of the pieces of content to be distributed should be subjected to encoding processing, the content distribution processor 62 controls the content management unit 63 to supply the one of the pieces of content to the content encoder 64. The content encoder 64 encodes the one of the pieces of content supplied from the content management unit 63 in accordance with a predetermined method and supplies the one of the pieces of content to the content distribution processor 62. The content distribution processor 62 supplies the one of the pieces of content supplied from the content encoder 64 to the network I/F unit 61.

The network I/F unit 61 transmits the one of the pieces of content supplied from the content distribution processor 62 to the controller 11.

When the server 12 distributes the one of the pieces of content to be reproduced which is selected by the user to the controller 11, the network I/F unit 50 included in the controller 11 receives the one of the pieces of content transmitted from the server 12 in step S16 and supplies the received one of the pieces of content to the content decoder 46 through the content reception processor 45.

Subsequently, in step S17, the content display reproduction controller 47 controls reproduction of the one of the pieces of content, and then, the reproducing processing is terminated. Specifically, the content decoder 46 decodes the one of the pieces of content supplied from the network I/F unit 50 and supplies the decoded one of the pieces of content to the content display reproduction controller 47. Then, the content display reproduction controller 47 supplies the one of the pieces of content supplied from the content decoder 46 to the display unit so that an image corresponding to the one of the pieces of content is displayed or supplies the one of the pieces of content to the speaker so that audio corresponding to the one of the pieces of content is output.

On the other hand, in a case where it is determined that the one of the pieces of content is not reproducible using the controller 11 in step S14, that is, for example, in a case where, in the content list 111 shown in FIG. 3, “video content 5” is selected to be reproduced, the reproduction determination unit 44 instructs the profile information obtaining unit 48 to obtain pieces of profile information of the renderers 13 and the process proceeds to step S18.

In step S18, the profile information obtaining unit 48 detects the renderers 13 connected to the network 14.

For example, the profile information obtaining unit 48 transmits a request for transmission of device information used to identify the renderers 13 through the network I/F unit 50 to all devices connected to the network 14. When receiving the request for transmission of device information, the renderers 13 transmit pieces of device information identifying themselves to the controller 11. For example, the device information management unit 72 stores therein the pieces of device information identifying the renderers 13. When receiving the request for transmission of device information from the network I/F unit 71, the device information management unit 72 transmits the device information stored therein to the controller 11 through the network I/F unit 71.

The profile information obtaining unit 48 included in the controller 11 receives the pieces of device information transmitted from the renderers 13 through the network I/F unit 50. In this way, the profile information obtaining unit 48 recognizes all the renderers 13 connected to the network 14.

Note that, alternatively, when all the devices are connected to the network 14, the all the devices such as the controller 11 and the renderers 13 may transmit/receive the pieces of device information of themselves to/from one another.

In this case, every time an additional renderer 13 is newly connected to the network 14, the profile information obtaining unit 48 obtains device information of the renderer 13 newly connected to the network 14. Accordingly, when the profile information obtaining unit 48 tries to detect the renderers 13 connected to the network 14, the profile information obtaining unit 48 refers to the pieces of device information which have already been obtained and stored.

In step S19, the profile information obtaining unit 48 transmits a request for transmission of profile information to all the renderers 13 detected by an operation performed in step S18 through the network I/F unit 50. Specifically, the profile information obtaining unit 48 supplies the request for transmission of profile information to the network I/F unit 50, and the network I/F unit 50 transmits the request for transmission of profile information to the renderers 13.

When the controller 11 transmits the request for transmission of profile information to the renderers 13, the network I/F unit 71 of each of the renderers 13 receives the request for transmission of profile information transmitted from the controller 11 and supplies the request to the device information management unit 72 in step S71.

In step S72, in response to the request for transmission of profile information supplied from the network I/F unit 71, the device information management unit 72 transmits the profile information stored therein to the controller 11 through the network I/F unit 71. Specifically, the device information management unit 72 supplies the profile information to the network I/F unit 71, and the network I/F unit 71 transmits the profile information to the controller 11.

In this way, pieces of profile information of all the renderers 13 are transmitted to the controller 11. In step S20, the network I/F unit 50 included in the controller 11 receives the pieces of profile information transmitted from the renderers 13. The network I/F unit 50 supplies the pieces of profile information to the reproduction determination unit 44 through the profile information obtaining unit 48. Accordingly, the pieces of profile information corresponding to all the renderers 13 connected to the network 14 are supplied to the reproduction determination unit 44.

Note that the pieces of profile information of the renderers 13 may be obtained when the controller 11 is connected to the network 14 or when an additional renderer 13 is newly connected to the network 14 after the controller 11 is connected to the network 14.

In step S21, the controller 11 performs renderer selection processing, and then, the reproduction processing is terminated. The renderer selection processing will be described in detail hereinafter. Note that, in the renderer selection processing, the controller 11 selects one of the renderers 13 used to reproduce one of the pieces of content selected by the user on the basis of the obtained pieces of profile information, and transmits a control command to instruct reproduction of the one of the pieces of content to the selected one of the renderers 13. The control command transmitted to the selected one of the renderers 13 includes information used to identify one of the pieces of content, such as a content URI, a content name, and a content reproduction start position.

When the controller 11 transmits the control command to the selected one of the renderers 13, in step S73, the network I/F unit 71 included in the renderer 13 receives the control command transmitted from the controller 11 and supplies the control command to the command processor 74 through the control command receiver 73. The command processor 74 executes the control command, supplies the information used to identify one of the pieces of content to the content reception processor 75, and instructs reproduction of the one of the pieces of content in accordance with an instruction of the controller 11.

In step S74, the content reception processor 75 generates a content distribution request which is a request for distribution of the one of the pieces of content to be reproduced on the basis of the information which is used to specify the one of the pieces of content and which is supplied from the command processor 74 and transmits the content distribution request to the server 12 through the network I/F unit 71. That is, the content reception processor 75 supplies the content distribution request to the network I/F unit 71, and the network I/F unit 71 transmits the content distribution request to the server 12.

When the one of the renderers 13 transmits the content distribution request to the server 12, the network I/F unit 61 included in the server 12 determines whether the content distribution request is transmitted from the one of the renderers 13 in step S46.

When it is determined that the content distribution request is not transmitted from the one of the renderers 13 in step S46, operations to be performed in steps S47 and S48 are skipped and the distribution processing is terminated.

On the other hand, when it is determined that the content distribution request is transmitted from the one of the renderers 13 in step S46, the network I/F unit 61 receives the content distribution request transmitted from the one of the renderers 13 in step S47, and supplies the content distribution request to the content distribution processor 62.

In step S48, the content distribution processor 62 distributes the one of the pieces of content requested to be distributed in response to the content distribution request supplied from the network I/F unit 61, and the distribution processing is terminated.

Note that in a case where one of the pieces of content to be distributed should be subjected to encoding processing, the content distribution processor 62 controls the content management unit 63 to supply the one of the pieces of content to the content encoder 64. The content encoder 64 encodes the one of the pieces of content supplied from the content management unit 63 in accordance with a predetermined method and supplies the one of the pieces of content to the content distribution processor 62. The content distribution processor 62 supplies the one of the pieces of content supplied from the content encoder 64 to the network I/F unit 61.

The network I/F unit 61 transmits the one of the pieces of content supplied from the content distribution processor 62 to the corresponding one of the renderers 13.

In this way, the server 12 distributes one of the pieces of content which is selected by the user and which is to be reproduced to the one of the renderers 13. In step S75, the network I/F unit 71 included in the one of the renderers 13 receives the one of the pieces of content transmitted from the server 12 and supplies the one of the pieces of content to the content decoder 76 through the content reception processor 75.

In step S76, the content display reproduction controller 77 controls reproduction of the one of the pieces of content, and then, the reproduction processing is terminated. Specifically, the content decoder 76 decodes the one of the pieces of content supplied from the network I/F unit 71 and supplies the decoded one of the pieces of content to the content display reproduction controller 77. Then, the content display reproduction controller 77 may supply the one of the pieces of content supplied from the content decoder 76 to the display unit so that an image is displayed, or may supply the one of the pieces of content to the speaker so that audio is output. In this way, as shown in FIG. 3, for example, the image corresponding to the one of the pieces of content is displayed in the display screen 115 of the display unit of the corresponding one of the renderers 13.

Note that although all the renderers 13 connected to the network 14 perform the reproduction processing, processing from step S73 to step S76 is performed by only one of the renderers 13 selected to reproduce one of the pieces of content selected by the user but not performed by the other renderers 13 each of which does not receive the control command. Furthermore, in a case where the one of the pieces of content which is selected by the user is reproduced using the controller 11, the renderers 13 do not perform the reproduction processing.

As described above, in a case where one of the pieces of content selected by the user is reproducible using the controller 11, the controller 11 reproduces the one of the pieces of content whereas in a case where one of the pieces of content selected by the user is not reproducible using the controller 11, a corresponding one of the renderers 13 reproduces the one of the pieces of content.

As described above, since in a case where one of the pieces of content selected by the user is reproducible using the controller 11, the controller 11 reproduces the one of the pieces of content whereas in a case where one of the pieces of content selected by the user is not reproducible using the controller 11, a corresponding one of the renderers 13 connected to the network 14 reproduces the one of the pieces of content, an integrated operation system is provided for the user irrespective of a device used to reproduce one of the pieces of content. Consequently, operability for the user is improved.

That is, the user may view or listen to a desired one of the pieces of content with a simple operation of selecting one of the pieces of content in which the user wishes to view or listen to from the content list and instructing reproduction thereof.

This content reproduction system is realized with a minimum implementing load by utilizing a function of obtaining a content list from the server 12 and a function of obtaining profile information from one of the renderers 13 which are functions generally necessary for a device compatible with a specification of the DLNA (Digital Living Network Alliance).

Referring now to a flowchart shown in FIG. 5, the content list display processing performed in step S13 of FIG. 4A will be described.

When the pieces of content information are supplied from the content information obtaining unit 42 to the content list display controller 43, the content list display controller 43 generates display data used to display a content list in accordance with the pieces of content information in step S101.

That is, the content list display controller 43 supplies the pieces of content information to the reproduction determination unit 44. The reproduction determination unit 44 determines whether each of the pieces of content represented by the pieces of content information, that is, each of the pieces of content recorded in the server 12 is reproducible using the controller 11 in accordance with the supplied pieces of content information. The reproduction determination unit 44 supplies results of the determinations to the content list display controller 43. As with the processing performed in step S14, the profile information of the controller 11 and the content attribute information are used for the determination processing performed using the reproduction determination unit 44.

For example, the content list display controller 43 generates the display data used to display the content list using the pieces of content information and the results of the determinations made using the reproduction determination unit 44. Specifically, the display data is generated so that pieces of information representing the pieces of content corresponding to the pieces of content information are arranged in a predetermined order and so that, among the pieces of information representing the pieces of content, a piece of information representing one of the pieces of content which is not reproducible using the controller 11 is displayed in a display format different from that used for the other pieces of information representing the other pieces of content which are reproducible using the controller 11.

In step S102, the content list display controller 43 supplies the generated display data to the display unit so that the content list is displayed. In the display screen 101 of the display unit, for example, the content list 111 shown in FIG. 3 is displayed. When the content list 111 is displayed in the controller 11, the user operates the input unit of the controller 11 to move the cursor 112 displayed in the content list 111 so as to instruct reproduction of one of the pieces of content.

In step S103, the input receiver 41 accepts an operation of selecting the one of the pieces of content performed by the user, that is, an operation of instructing the reproduction of the one of the pieces of content. In accordance with an operation signal supplied from the input unit, the input receiver 41 instructs the reproduction determination unit 44 to reproduce the one of the pieces of content selected by the user. Then, the process proceeds to step S14 of FIG. 4A.

In this way, the controller 11 displays the content list. In the content list displayed in the controller 11, since the pieces of information representing content which are reproducible using the controller 11 and the piece of information representing content which is not reproducible using the controller 11 are displayed in display formats different from each other, the user immediately recognizes pieces of content which are allowed to be reproduced using the controller 11 by only checking the content list.

The controller 11 displays not only the pieces of information representing pieces of content which are reproducible using the controller 11 but also the piece of information representing a piece of content which is not reproducible using the controller 11. In this state, when the piece of information representing the piece of content which is not reproducible using the controller 11 is selected, the selected piece of content is reproduced using a corresponding one of the renderers 13. Accordingly, the user has many opportunities to view and listen to many pieces of content.

Referring to a flowchart of FIG. 6, renderer selection processing corresponding to processing performed in step S21 of FIG. 4B will be described.

In step S131, the reproduction determination unit 44 determines whether one of the pieces of content selected by the user is reproducible using the renderers 13 on the basis of the pieces of content information supplied from the content list display controller 43 and the pieces of profile information supplied from the profile information obtaining unit 48.

That is, the reproduction determination unit 44 checks all the renderers 13 detected in step S18 to determine whether the selected one of the pieces of content is reproducible using the individual renderers 13. When it is determined that the selected one of the pieces of content is not reproducible using any one of the renderers 13, the reproduction determination unit 44 determines that the selected of the pieces of content is non-reproducible content for all the renderers 13.

As with the processing performed in step S14 of FIG. 4A, as for the determination as to whether the selected one of the pieces of content is reproducible using one of the renderers 13, for example, when the one of the renderers 13 is not compatible with a category, a codec, a size of an image to be displayed, or a protocol used at a time of transmission which are included in the content attribute information, the reproduction determination unit 44 determines that the one of the pieces of content selected by the user is not reproducible using the one of the renderers 13.

When it is determined that the selected one of the pieces of content is reproducible using one of the renderers 13 in step S131, the reproduction determination unit 44 determines whether, among the renderers 13, a default renderer 13 has been specified to reproduce the selected one of the pieces of content in step S132.

For example, the reproduction determination unit 44 records the default renderer 13 therein in advance. The default renderer 13 may be one of the renderers 13 which is detected first after the controller 11 is activated or in the processing in step S18 in FIG. 4B, one of the renderers 13 which is selected by the user as a default renderer 13 in advance, or one of the renderers 13 which was selected by the user to be used to reproduce one of the pieces of content the last time using the renderer selection screen 113 of FIG. 3.

For example, one of the renderers 13 which is detected first has high responsibility. Therefore, in a case where one of the renderers 13 which is detected first is set as a default renderer 13, one of the pieces of content selected by the user is immediately reproduced using the default renderer 13.

In a case where one of the renderers 13 which is selected by the user is set as the default renderer 13 in advance, since the user selected a desired one of the renderers 13 as a default renderer 13 used to reproduce a selected one of the pieces of content, it is not necessary to select one of the renderers 13 every time the user wish to reproduce one of the pieces of content. Note that, in this case, the user may set the default renderer 13 which is used to reproduce the pieces of content for individual categories.

Furthermore, one of the renderers 13 selected by the user the last time is highly likely to be selected again this time. For example, in a case where the user often views and listens to one of the pieces of content in a living room at home, the user selects one of renderers 13 which is provided in the living room. That is, one of the renderers 13 which was selected the last time by the user is highly likely to be selected again to reproduce the one of the pieces of content selected by the user. Therefore, if one of the renderers 13 selected the last time is set as a default renderer 13, it is not necessary for the user to select one of the renderers 13 every time one of the pieces of content is reproduced.

In step S132, when it is determined that the default renderer 13 has been set, the reproduction determination unit 44 instructs the renderer controller 49 to supply information about the default renderer 13 and information used to specify the selected one of the pieces of content, such as a content URI, a content name, and a content reproduction starting position, and to reproduce the selected one of the pieces of content. Then, the process proceeds to step S135.

That is, the reproduction determination unit 44 detects, among the renderers 13, renderers 13 capable of reproducing the selected one of the pieces of content in step S131, and further selects, among the detected renderers 13 capable of reproducing the selected one of the pieces of content, a default renderer 13 as a renderer 13 used to reproduce the selected one of the pieces of content. Furthermore, the reproduction determination unit 44 instructs the renderer controller 49 to reproduce the selected one of the pieces of content using the default renderer 13.

On the other hand, when it is determined that the default renderer 13 is not specified in step S132, the reproduction determination unit 44 supplies pieces of information about the renderers 13 capable of reproducing the selected one of the pieces of content to the content list display controller 43, and instructs the content list display controller 43 to display the renderer selection screen. Then, the process proceeds to step S133.

In step S133, in accordance with the pieces of information about the renderers 13 capable of reproducing the one of the pieces of content which are supplied from the reproduction determination unit 44, the content list display controller 43 generates display data used to display the renderer selection screen in which the pieces of information about the renderers 13 capable of reproducing the selected one of the pieces of content are arranged, and displays the display data on the renderer selection screen.

In this way, in the display unit, the renderer selection screen 113 as show in FIG. 3, for example, is displayed along with the content list. The user moves the cursor 114 by operating the input unit so as to select one of the pieces of information representing the renderers 13 which is used to reproduce a desired one of the pieces of content.

In step S134, the reproduction determination unit 44 selects one of the renderers 13 to reproduce the one of the pieces of content in accordance with a user's operation. That is, when the user selects a desired one of the renderers 13 using the renderer selection screen by operating the input unit, the input receiver 41 supplies a corresponding one of the pieces of information representing the selected one of the pieces of content in response to an operation signal supplied from the input unit. In accordance with the one of the pieces of information supplied from the input receiver 41, the reproduction determination unit 44 selects one of the renderers 13 which is to be used to reproduce the content. Then, the reproduction determination unit 44 supplies one of the pieces of information representing the selected one of the renderers 13 and one of the pieces of information corresponding to the one of the pieces of content to the renderer controller 49, and instructs the renderer controller 49 to reproduce the one of the pieces of content. Then, the process proceeds to step S135.

When the one of the renderers 13 is selected in step S134 or when it is determined that a default renderer 13 has been specified in step S132, the renderer controller 49 transmits a control command used to instruct reproduction of the selected one of the pieces of content through the network I/F unit 50 to the corresponding one of the renderers 13 in accordance with an instruction issued from the reproduction determination unit 44 in step S135. The reproduction processing is thus terminated. Here, the control command includes information used to specify the selected one of the pieces of content to be reproduced.

Note that, when it is determined that the selected one of the pieces of content is not reproducible using any of the renderers 13 in step S131, that is, when any of the renderers 13 connected to the network 14 is not capable of reproducing the selected one of the pieces of content, the reproduction determination unit 44 instructs the content list display controller 43 to display an error notification. Then, the process proceeds to step S136.

In step S136, the content list display controller 43 displays the error notification in the display unit in response to the instruction issued by the reproduction determination unit 44, and the reproduction processing is thus terminated. For example, the content list display controller 43 supplies display data to the display unit so that a message “Content is not reproducible”, for example, is displayed.

As described above, the controller 11 determines renderers 13 capable of reproducing a selected one of the pieces of content among the renderer 13 connected to the network 14. In addition, if the controller 11 determines that a default renderer 13 is specified among the renderers 13 capable of reproducing the one of the pieces of content, the default renderer 13 is used to reproduce the one of the pieces of content. On the other hand, if the controller 11 determines that the default renderer 13 is not specified among the renderers 13 capable of reproducing the one of the pieces of content, one of the renderers 13 is selected by the user using the renderer selection screen as a renderer used to reproduce the one of the pieces of content.

As described above, in a case where a default renderer 13 is specified among the renderers 13 capable of reproducing the selected one of the pieces of content, the default renderer 13 is used to reproduce the selected one of the pieces of content without complicated operations for the user.

That is, even in a case where one of the pieces of content selected by the user is not reproducible using the controller 11, the user may view or listen to the selected one of the pieces of content by performing a simple operation of selecting one of the pieces of information which represents the selected one of the pieces of content to be reproduced.

Furthermore, even in a case where a default renderer 13 is not specified among the renderers 13 capable of reproducing the selected one of the pieces of content, since the renderer selection screen is displayed without any user's operation, the user may view or listen to the selected one of the pieces of content only by selecting one of the pieces of information which represent the renderers 13 using the renderer selection screen.

In a case where a default renderer 13 is not set and it is determined that the selected one of the pieces of content is reproducible using at least one of the renderers 13 in step S131, the renderer selection screen may be displayed at all times.

A series of processes described above may be executed using hardware or software. In a case where the series of processes is executed using the software, programs constituting the software may be executed using a computer incorporated in dedicated hardware or may be installed from a program recording medium to, for example, a general personal computer capable of executing various functions by installing various programs.

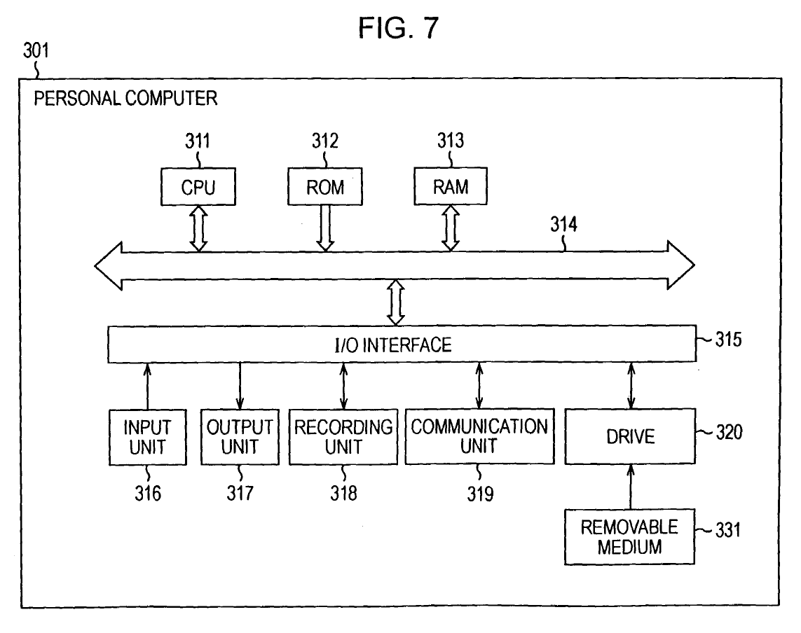

FIG. 7 is a block diagram illustrating an example of a configuration of a personal computer which executes the series of processes described above in accordance with programs. A CPU (Central Processing Unit) 311 included in a personal computer 301 performs various processes in accordance with programs recorded in a ROM (Read Only Memory) 312 or a recording unit 318. The programs and data to be executed by the CPU 311 are stored in a RAM (Random Access Memory) 313 as needed. The CPU 311, the ROM 312, and the RAM 313 are connected to one another via a bus 314.

An input/output interface 315 is connected to the CPU 311 via the bus 314. An input unit 316 including a keyboard, a mouse, and a microphone, and an output unit 317 including a display and a speaker are connected to the input/output interface 315. The CPU 311 performs various processes in accordance with instructions input from the input unit 316. The CPU 311 outputs results of the processes to the output unit 317.

The recording unit 318 connected to the input/output interface 315 is constituted by hardware, for example, and stores programs and a variety of data executed by the CPU 311 therein. A communication unit 319 communicates with an external device through a network such as the Internet or a local area network.

The communication unit 319 may be used to obtain programs to be recorded in the recording unit 318.

A drive 320 connected to the input/output interface 315 drives a removable medium 331 such as a magnetic disc, an optical disc, a magneto-optical disc, or a semiconductor memory which is loaded in the input/output interface 315 so as to obtain programs and data recorded in the removable medium 331. The obtained programs and the data are transmitted to the recording unit 318 as needed and recorded therein.

A program recording medium storing programs which are to be installed in a computer and which are executable using the computer includes, as show in FIG. 7, the removable medium 331, the ROM 312, and a hard disc. The removable medium 331 is a package medium such as a magnetic disc (including a flexible disc), an optical disc (including a CD-ROM (Compact Disc-Read Only Memory), a DVD (Digital Versatile Disc), a magneto-optical disc, or a semiconductor memory. The ROM 312 temporarily or permanently stores the programs. The hard disc constitutes the recording unit 318. The programs are stored in such a program recording medium using a wired or a wireless communication medium such as a local area network, the Internet, or digital satellite broadcasting via the communication unit 319 which is an interface such as a rooter and a modem.

The steps describing the programs stored in the program recording medium may be executed on a time-series basis in an order of the description herein, or may be executed in parallel or individually.

It should be understood by those skilled in the art that various modifications, combinations, sub-combinations and alterations may occur depending on design requirements and other factors insofar as they are within the scope of the appended claims or the equivalents thereof.

What is claimed is:

1. A content reproducing system including an electronic apparatus, a content provision apparatus used to provide pieces of content, and one or more reproducing apparatuses used to reproduce the pieces of content, the electronic apparatus, the content provision apparatus, and the one or more reproducing apparatuses being connected to one another via a network, wherein
the electronic apparatus includes,
display controlling means for controlling display of a content list which is a list of the pieces of content provided by the content provision apparatus,
selecting means for selecting, among the one or more reproducing apparatuses, a reproducing apparatus capable of reproducing one of the pieces of content selected from the content list to reproduce the selected one of the pieces of content, and
instructing means for instructing the selected reproducing apparatus to reproduce the selected one of the pieces of content,
each of the one or more reproducing apparatuses includes,
requesting means for requesting the content provision apparatus to transmit the selected one of the pieces of content instructed to be reproduced using the instructing means,
receiving means for receiving the selected one of the pieces of content transmitted from the content provision apparatus through the network in response to the request issued using the requesting means, and
reproduction controlling means for controlling reproduction of the selected one of the pieces of content received using the receiving means, and
the content provision apparatus includes,
recording means for recording the pieces of content, and
transmitting means for transmitting the selected one of the pieces of content requested to be transmitted to the selected reproducing apparatus.

2. An electronic apparatus comprising:
display controlling means for controlling display of a content list which is a list of pieces of content;
selecting means for selecting, among one or more apparatuses connected to one another through a network, an apparatus capable of reproducing one of the pieces of content selected from the content list to reproduce the selected one of the pieces of content; and
instructing means for instructing the selected apparatus to reproduce the selected one of the pieces of content.

3. The electronic apparatus according to claim 2, further comprising:
reproduction controlling means for controlling reproduction of the selected one of the pieces of content,
wherein the selecting means determines whether the selected one of the pieces of content is reproducible using the electronic apparatus,
the reproduction controlling means controls the reproduction of the selected one of the pieces of content when it is determined that the selected one of the pieces of content is reproducible using the electronic apparatus, and
the instructing means instructs the selected apparatus to reproduce the selected one of the pieces of content when it is determined that the selected one of the pieces of content is not reproducible using the electronic apparatus.

4. The electronic apparatus according to claim 3,
wherein the display controlling means controls display of the content list so that, in the content list, pieces of information representing pieces of content which are not reproducible using the electronic apparatus are displayed in a display format different from a display format for pieces of information representing pieces of content which are reproducible using the electronic apparatus.

5. The electronic apparatus according to claim 3, further comprising:
receiving means for receiving pieces of profile information which represent a function of reproducing one of the pieces of content, which are included in the corresponding one or more apparatuses, and which are transmitted through the network from the one or more apparatuses,
wherein, on the basis of the pieces of profile information, the selecting means selects, among the one or more apparatuses, at least one apparatus capable of reproducing the selected one of the pieces of content, and further selects, among the at least one apparatus capable of reproducing the selected one of the pieces of content, an apparatus to reproduce the selected one of the pieces of content.

6. The electronic apparatus according to claim 5,
wherein the display controlling means controls a list of the one or more apparatuses capable of reproducing the selected one of the pieces of content, and
the selecting means selects, from the list of the one or more apparatuses, an apparatus which reproduces the selected one of the pieces of content.

7. The electronic apparatus according to claim 5,
wherein the selecting means selects, among the one or more apparatuses capable of reproducing the selected one of the pieces of content, an apparatus which reproduced one of the pieces of content the last time, an apparatus which is detected first on the network, or an apparatus specified by a user in advance, as an apparatus which reproduces the selected one of the pieces of content.

8. A reproduction control method comprising the steps of:
controlling display of a content list which is a list of pieces of content;
selecting, among one or more apparatuses connected to one another through a network, an apparatus capable of reproducing one of the pieces of content selected from the content list to reproduce the selected one of the pieces of content; and
controlling an instruction for reproducing the selected one of the pieces of content which is to be issued to the selected apparatus.

9. A storage medium including a program which makes a computer execute the steps of:
controlling display of a content list which is a list of pieces of content;
selecting, among one or more apparatuses connected to one another through a network, an apparatus capable of reproducing one of the pieces of content selected from the content list to reproduce the selected one of the pieces of content; and
controlling an instruction for reproducing the selected one of the pieces of content which is to be issued to the selected apparatus.

10. A content reproducing system including an electronic apparatus, a content provision apparatus used to provide pieces of content, and one or more reproducing apparatuses used to reproduce the pieces of content, the electronic apparatus, the content provision apparatus, and the one or more reproducing apparatuses being connected to one another via a network, wherein
the electronic apparatus includes,
a display controller configured to control display of a content list which is a list of the pieces of content provided by the content provision apparatus,
a selecting unit configured to select, among the one or more reproducing apparatuses, a reproducing apparatus capable of reproducing one of the pieces of content selected from the content list to reproduce the selected one of the pieces of content, and
an instructing unit configured to instruct the selected reproducing apparatus to reproduce the selected one of the pieces of content,
each of the one or more reproducing apparatuses includes,
a requesting unit configured to request the content provision apparatus to transmit the selected one of the pieces of content instructed to be reproduced using the instructing unit,
a receiving unit configured to receive the selected one of the pieces of content transmitted from the content provision apparatus through the network in response to the request issued using the requesting unit, and
a reproduction controlling unit configured to control reproduction of the selected one of the pieces of content received using the receiving unit, and
the content provision apparatus includes,
a recording unit configured to record the pieces of content, and
a transmitting unit configured to transmit the selected one of the pieces of content requested to be transmitted to the selected reproducing apparatus.

11. An electronic apparatus comprising:
a display controlling unit configured to control display of a content list which is a list of pieces of content;
a selecting unit configured to select, among one or more apparatuses connected to one another through a network, an apparatus capable of reproducing one of the pieces of content selected from the content list to reproduce the selected one of the pieces of content; and
an instructing unit configured to instruct the selected apparatus to reproduce the selected one of the pieces of content.
